(19) United States
(12) Patent Application Publication
(10) Pub. No.: US 2014/0012960 A1
(43) Pub. Date: Jan. 9, 2014

(54) NETWORK CONNECTION SETTING SYSTEM, NETWORK ELECTRONIC DEVICE AND CONNECTION SETTING METHOD THEREOF

(71) Applicant: HUANG-JEN CHIEN, New Taipei City (TW)

(72) Inventor: HUANG-JEN CHIEN, New Taipei City (TW)

(73) Assignee: AV TECH CORPORATION, New Taipei City (TW)

(21) Appl. No.: 13/606,776

(22) Filed: Sep. 7, 2012

(30) Foreign Application Priority Data
Jul. 9, 2012 (TW) 101124692

(51) Int. Cl. G06F 15/177

(52) U.S. Cl. 709/220

(57) ABSTRACT

The present invention provides a network connection setting system, a network electronic device and a connection setting method thereof. The network connection setting system includes a network electronic device and an external display device. The network electronic device has a transmission function of a wireless personal area network to selectively transmit a wireless link signal. The external display device has a transmission function of a wireless personal area network to receive the wireless link signal for connecting matchedly with the network electronic device. The external display device is used for inputting configuration information for network connection setting of the network electronic device.

### CROSS-REFERENCE TO RELATED APPLICATION

This application claims the benefit under 35 U.S.C. §119 of Taiwanese Patent Application No. 101124692, filed Jul. 9, 2012, which is hereby incorporated by reference in its entirety.

### BACKGROUND

1. Field of the Invention

The present invention is related to a network connection setting system, a network electronic device and a connection setting method thereof, and specifically to a network connection setting system, a network electronic device and a connection setting method thereof for a network electronic device without display function having a bluetooth transmission interface, such that IP cams or other similar devices may be linked to an external display device via the bluetooth transmission interface to make the network electronic device without display function installed faster and more convenient without inputting network setting parameters by a user himself.

2. Description of Related Art

With the development and advancement of current technology, a variety of electronic devices are linked to remote servers through network to obtain handier and more multiple services and information. Taking webcam devices as an example, security monitoring systems are essential equipment of office buildings, private houses, apartments and factories. People may have a video conference through remote network, watch children's activities or execute security supervisory control or the like.

With the development and advancement of current technology, a variety of electronic devices are linked to remote servers through network to obtain handier and more multiple services and information. Taking IP cams as an example, such devices used in security monitoring systems are essential equipment of office buildings, private houses, apartments and factories. People may have a video conference through remote network, watch children's activities or execute security supervisory control or the like.

However, due to the IP cams having no display function, network connection settings cannot executed on the webcams as installed at the first time. Thus, the environment parameters (i.e. network configuration settings) of the IP cams are usually set by an external computer, and then the network connection settings of the IP cams are executed through the external computer. Accordingly, the executions of setting and using are greatly inconvenient.

### BRIEF SUMMARY

In view of the problems of the prior art described above, the objective of the present invention is to provide a network connection setting system, network electronic device and connection setting method thereof, in order to solve the problems of the requirement of an external computer for auxiliary installation of the network electronic devices (such as webcams) without display function, as well as the inconvenience of installation due to inputting the network setting parameters by a user himself.

According to the objectives of the present invention, a network connection setting system according to the present invention is provided, comprising:

a network electronic device having a transmission function of a wireless personal area network to selectively transmit a wireless link signal; and

an external display device having a transmission function of a wireless personal area network to receive the wireless link signal for connecting matchedly with the network electronic device, and providing a user to input configuration information for network connection setting of the network electronic device.

Preferably, the network electronic device captures images to create image information after finishing network connection setting, and the external display device spontaneously receives and displays the image information and is used for inputting image adjustment information according to the image information to adjust the shooting angle and focusing distance of the network electronic device.

Preferably, both the network electronic device and the external display device have bluetooth transmission interfaces to establish the wireless personal area network.

Preferably, the network electronic device has computer codes of a setting interface stored therein, and the computer codes are loaded to the external display device and the setting interface is displayed on the external display device for providing a user to input the configuration information according to the setting interface.

Preferably, the external display device is a mobile phone, a tablet personal computer, a laptop computer or a personal digital assistant.

Preferably, the network electronic device is an IP cam.

According to the objectives of the present invention, a connection setting method used in a network electronic device to execute connection settings is also provided and comprising steps of:

turning on a transmission function of a wireless personal area network of the network electronic device to transmit a wireless link signal;

turning on a transmission function of a wireless personal area network of an external display device to receive the wireless link signal for connecting matchedly with the network electronic device; and

using the external display device to input configuration information for network connection setting of the network electronic device.

Preferably, the method of the present invention further comprises steps of:

using the network electronic device to capture images to create image information after finishing the network connection setting, and using the external display device to synchronically receive and display the image information; and

using the external display device to input image adjustment information according to the image information, in order to adjust the shooting angle and focusing distance of the network electronic device.

Preferably, both the network electronic device and the external display device have bluetooth transmission interfaces to establish the wireless personal area network.

Preferably, the method of the present invention further comprises a step of:

providing computer codes of a setting interface via the network electronic device to the external display device, and the computer codes are loaded to the external display device and using the external display device to display the setting interface used for inputting the configuration information according to the setting interface.

According to the objectives of the present invention, a network electronic device is further provided, and having a transmission function of a wireless personal area network to selectively transmit a wireless link signal toward an external display device for matched connection and input configuration information via the external display device for network connection setting of the network electronic device, wherein the external device also has a transmission function of a wireless personal area network to receive the wireless link signal.

Preferably, the network electronic device captures images to create image information after finishing network connection setting, and the external display device synchronically receives and displays the image information and is used for inputting image adjustment information according to the image information to adjust the shooting angle and focusing distance of the network electronic device.

Preferably, both the network electronic device and the external display device have bluetooth transmission interfaces to establish the wireless personal area network.

Preferably, the network electronic device has computer codes of a setting interface stored therein, and the computer codes are loaded to the external display device and the setting interface is displayed on the external display device used for inputting the configuration information according to the setting interface.

Preferably, the network electronic device is an IP cam.

As described above, the network connection setting system, the network electronic device and the connection setting method thereof in accordance with the present invention have one or more following advantages:

(1) The network connection setting system, the network electronic device and the connection setting method thereof is applied to set up a bluetooth transmission interface in a network electronic device without display function, such as IP cams, such that the network electronic device may perform wireless connections toward an external display device via the bluetooth transmission interface, in order to execute connection settings for the network electronic device directly via the external display device without restriction of the utilization of cables, and finish the installation without inputting network setting parameters by a user himself.

(2) In accordance with the present invention, the external display device is used to synchronically receive and display the image information created by images captured by the network electronic device, and for a user to adjust the shooting angle and focusing distance of the IP cams through an external display device without located in front of the network electronic device, and thus make more convenience of the adjustment of image settings.

### BRIEF DESCRIPTION OF THE DRAWINGS

FIG. 1 is block diagram of a network connection system in accordance with the present invention.

FIG. 2 is a flow diagram of the connection setting method of the network electronic device in accordance with the present invention.

FIG. 3 is a first schematic view of an embodiment of executing connection settings of a network electronic device in accordance with the present invention.

FIG. 4 is a second schematic view of an embodiment of executing connection settings of a network electronic device in accordance with the present invention.

FIG. 5 is a third schematic view of an embodiment of executing connection settings of a network electronic device in accordance with the present invention.

### DETAILED DESCRIPTION

For the benefit of understanding the technical characteristics, contents and advantages of the present invention, the present invention is described in detail by the following examples and drawings. The drawings attached herein are only used to illustrate and accessorily explain the principle of the present invention, not to show the real configurations and ratios of the elements or devices according to the present invention. Therefore, the scope of the claimed invention should not be limited to the ratios and configurations of the devices/elements in the embodiments and drawings below.

The exemplary embodiments of a network connection setting system, network electronic device and connection setting method thereof in accordance with the present invention is more specifically described in the following paragraphs by reference to the drawings attached only by way of examples. For convenience of understanding the principles of the invention, the same elements/components having same functions or structures in any of the following examples are marked as the same numbers or symbols.

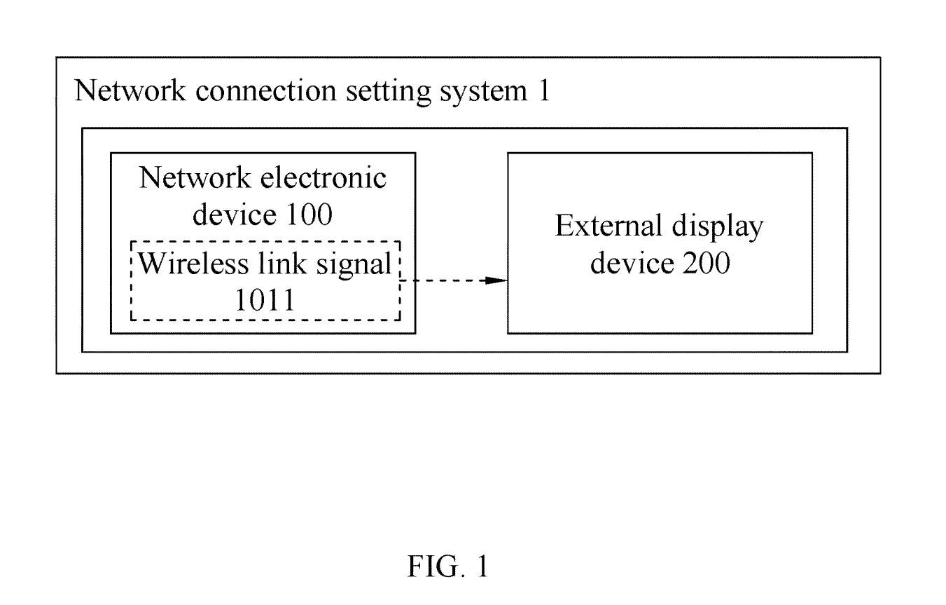

With reference to FIG. 1, in which a block diagram of a network connection system in accordance with the present invention in illustrated. As shown in FIG. 1, the network connection setting system 1 comprises a network electronic device 100 and an external display device 200. The network electronic device 100 has a transmission function of a wireless personal area network that used to selectively transmit a wireless link signal 1011. Similarly, the external display device 200 also has a transmission function of a wireless personal area network that used to receive the wireless link signal 1011 for connecting matchedly with the network electronic device 100. The external display device 200 is used for inputting configuration information for network connection setting of the network electronic device 100.

As mentioned above, the network electronic device 100 may be any type or model of internet protocol cameras (IP cam). The external device 200 may be a mobile apparatus or a handheld electronic product, which may comprise a mobile phone, a tablet computer, a laptop computer or a personal digital assistant, or the like. The description above is taken as examples, not to limit the invention.

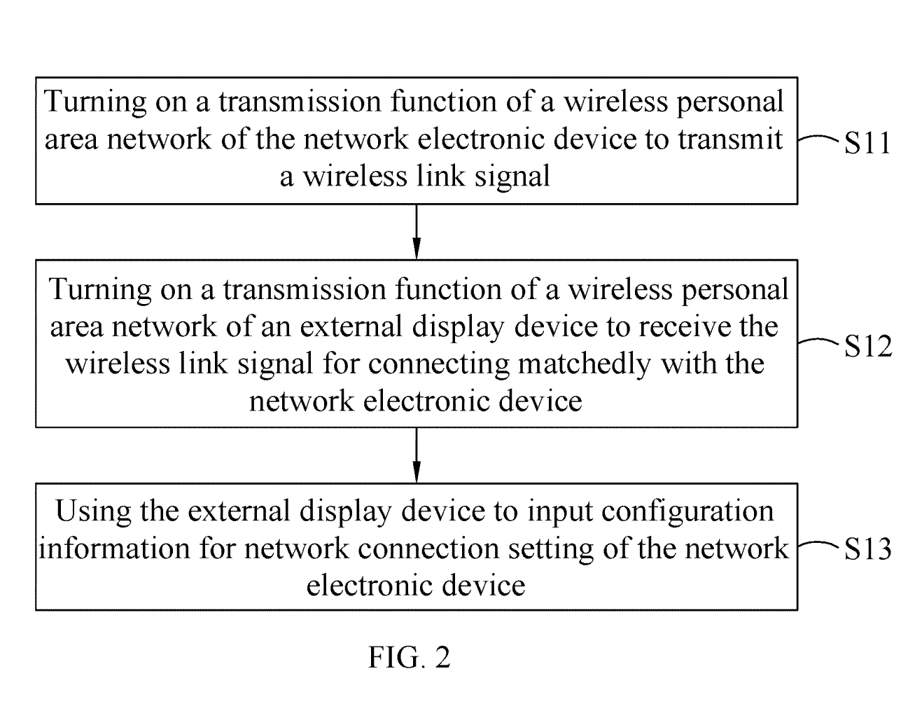

With reference to FIG. 2, in which a flow diagram of the connection setting method of the network electronic device in accordance with the present invention in illustrated. The method comprises steps of:

S11: turning on a transmission function of a wireless personal area network of a network electronic device to transmit a wireless link signal;

S12: turning on a transmission function of a wireless personal area network of an external display device to receive a wireless link signal for connecting matchedly with the network electronic device; and

S13: using the external display device to input configuration information for network connection settings of the network electronic device.

In one aspect, the network electronic device and the external display device may establish the wireless personal area network thereof by using bluetooth transmission interfaces.

As mentioned above, the objective of the network connection setting system, the network electronic device and the connection setting method thereof in accordance with the present invention, is mainly to install the connection of the network electronic device 100 without display function toward network. A variety of the network electronic device 100 without display function may be used in the present invention. In the following embodiments, an IP cam is taken as an example of the network electronic device 300 mentioned herein and just for illustrating a preferred embodiment, not to limit the network electronic device 300 to the IP cam.

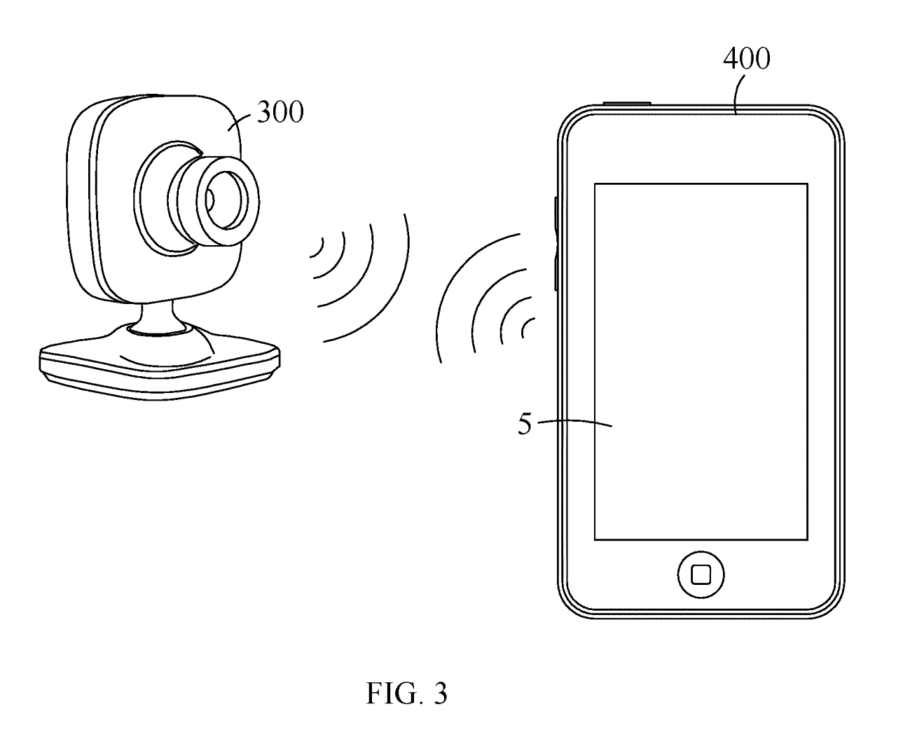

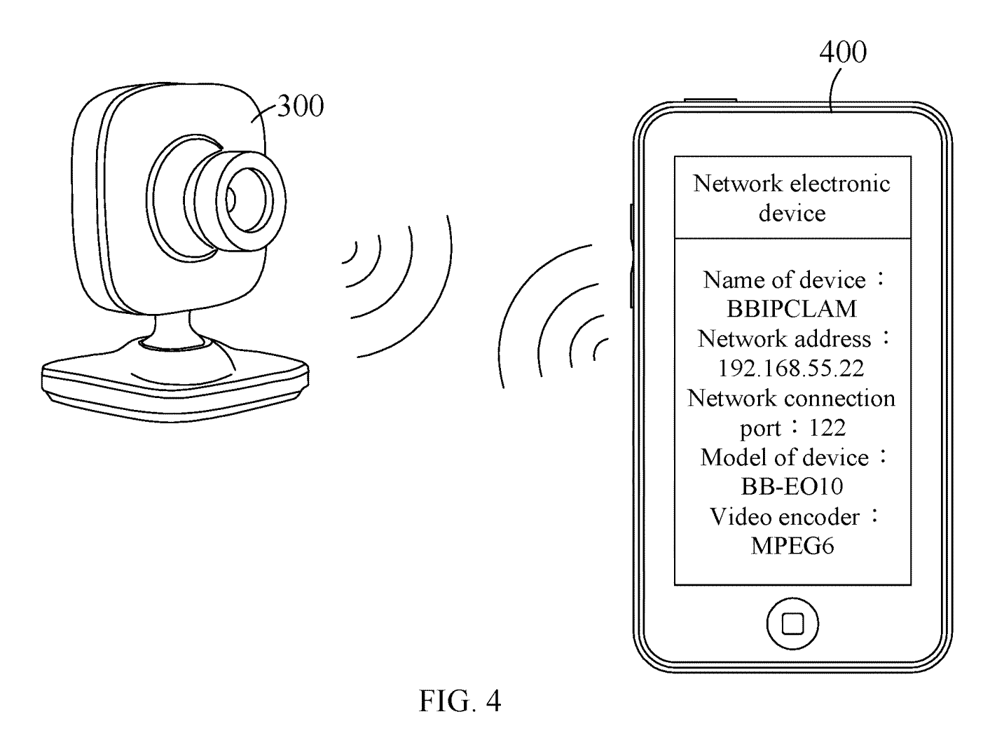

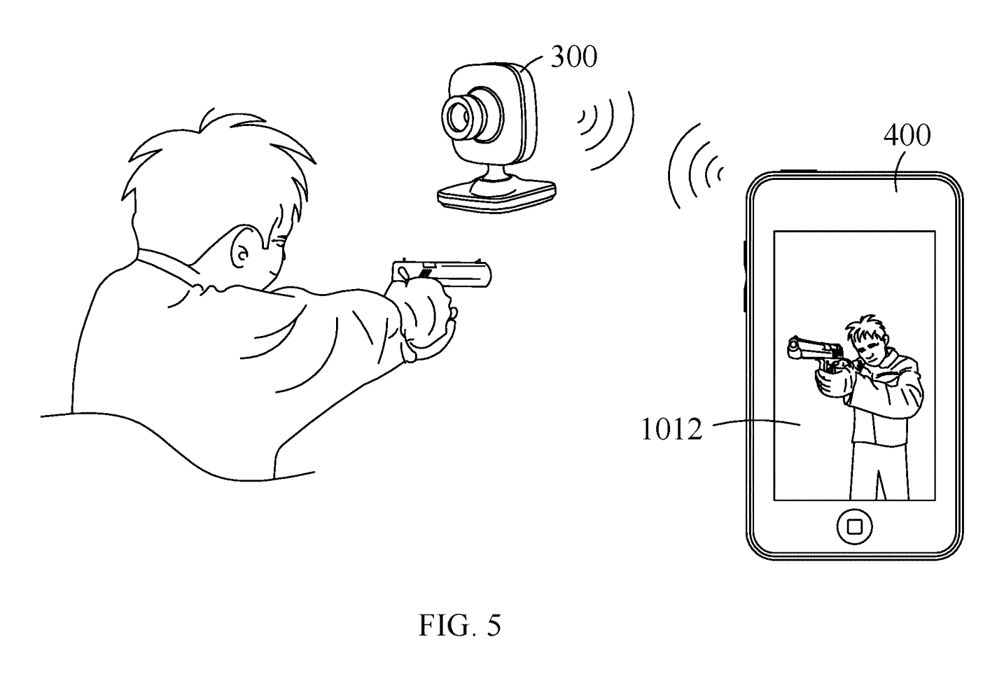

With reference to FIGS. 3 to 5, FIG. 3 is a first schematic view of an embodiment of executing connection settings of a network electronic device in accordance with the present invention; FIG. 4 is a second schematic view of an embodiment of executing connection settings of a network electronic device in accordance with the present invention; FIG. 5 is a third schematic view of an embodiment of executing connection settings of a network electronic device in accordance with the present invention. In the embodiments, both the network electronic device 300 and the external display device 400 have bluetooth transmission interfaces to establish the wireless personal area network. Thus, the network electronic device 300 does not require to be connected to an external computer device via a cable for executing the network connection settings as installed at the first time. User just needs to turn on the transmission function of a wireless personal area network of the network electronic device 300 to connect matchedly to the external display device 400, thereby the external display device 400 may be used for executing the network connection settings according to configuration information displayed thereon, as shown in FIG. 3. In one aspect, the external display device may comprise a mobile phone, a tablet computer, a laptop computer or a personal digital assistant, or other mobile apparatus, such as iPhone or iPad. The description above is only to illustrate preferred embodiments, not to limit the contents and scopes of the present invention.

As mentioned above, the network electronic device 300 has computer codes of a setting interface 5 stored therein. The computer codes are loaded to the external display device. The setting interface 5 may be displayed on the external display device 400 and used for inputting the configuration information according to the setting interface 5, in order to establish the connection settings of the network connection for the network electronic device 300, as shown in FIG. 4. The configuration information may comprise names of devices, network addresses, network connection ports, models of devices or video encoders, or the like. The description above is to illustrate preferred embodiments only, not to limit the contents and scopes of the present invention.

As mentioned above, the network electronic device 300 captures images to create image information 1012 after finishing network connection setting, and the image information 1012 is transmitted to the external display device 400, while the external display device 400 synchronically receives and displays the image information 1012. A user may use the external display device 400 to input image adjustment information according to the image information 1012, in order to adjust the shooting angle and focusing distance of the network electronic device 300, as shown in FIG. 5. In one aspect, the image adjustment information may comprise a shooting angle, a focusing distance, or the like. The description above is to illustrate preferred embodiments only, not to limit the contents and scopes of the present invention.

Furthermore, the bluetooth transmission interface of the network electronic device 300 in accordance with the present invention may be not only used in the execution of the network connection settings, but also the functions of the input and output of videos or alarms with the external display device 400. As such, the problems about difficulties of waterproof design of cables, additional costs, and inconvenience of mechanism design in the cable connection between the network electronic device 300 and the external display device 400 may be overcome.

Overall, the network connection setting system, the network electronic device and the connection setting method thereof is used for a network electronic device without display function having a bluetooth transmission interface, such that the network electronic device has the transmission function of a wireless personal network area to be connected matchedly to an external display device through the wireless connection. The external display device is used for a user to input configuration information for the network connection settings of the network electronic device directly and make the network electronic device without display function, such as an IP cam, installed spontaneously without inputting network setting parameters by a user himself, thereby the present invention achieves the effect of simple installation of such devices like IP cams. Also, the images captured by the network electronic device may be synchronically received and displayed by the external display device, thereby the shooting angle and focusing distance of the network electronic device may be adjusted according to the images displayed on the external display device. Therefore, a user does not need to be located in front of the network electronic device to adjust the shooting angle and focusing distance resulting in the convenience of utilization.

In view of the foregoing description, it is obvious that the present invention breaks through the prior art and reaches the desired effects, and not be achieved easily by people skilled in the art. Furthermore, the contents of present invention are not known to public prior to filing an application and meet the requirement of the non-obviousness and utility of a patent.

Even though numerous characteristics and advantages of the present invention have been set forth in the foregoing description, the disclosure is illustrative only, not to limit the invention. Changes may be made in the details, and arrangement of parts within the principles of the invention to the full extent indicated by the broad general meaning of the terms in which the appended claims are expressed.

What is claimed is:

1. A network connection setting system, comprising:
a network electronic device having a transmission function of a wireless personal area network to selectively transmit a wireless link signal; and
an external display device having a transmission function of a wireless personal area network to receive the wireless link signal for connecting matchedly with the network electronic device, and used for inputting configuration information for network connection setting of the network electronic device.

2. The network connection setting system as claimed in claim 1, wherein the network electronic device captures images to create image information after finishing network connection setting, and the external display device spontaneously receives and displays the image information and is used for inputting image adjustment information according to the image information to adjust the shooting angle and focusing distance of the network electronic device.

3. The network connection setting system as claimed in claim 1, wherein both the network electronic device and the external display device have bluetooth transmission interfaces to establish the wireless personal area network.

4. The network connection setting system as claimed in claim 1, wherein the network electronic device has computer codes of a setting interface stored therein, and the computer codes are loaded to the external display device and the setting interface is displayed on the external display device for inputting the configuration information according to the setting interface.

5. The network connection setting system as claimed in claim 1, wherein the external display device is a mobile phone, a tablet personal computer, a laptop computer or a personal digital assistant.

6. The network connection setting system as claimed in claim 1, wherein the network electronic device is an IP cam.

7. A connection setting method used in a network electronic device to execute connection settings, comprising steps of:
turning on a transmission function of a wireless personal area network of the network electronic device to transmit a wireless link signal;
turning on a transmission function of a wireless personal area network of an external display device to receive the wireless link signal for connecting matchedly with the network electronic device; and
using the external display device to input configuration information for network connection setting of the network electronic device.

8. The method as claimed in claim 7, further comprising steps of:
using the network electronic device to capture images to create image information after finishing the network connection setting, and using the external display device to synchronically receive and display the image information; and
using the external display device to input image adjustment information according to the image information, in order to adjust the shooting angle and focusing distance of the network electronic device.

9. The method as claimed in claim 7, wherein both the network electronic device and the external display device have bluetooth transmission interfaces to establish the wireless personal area network.

10. The method as claimed in claim 7, further comprising a step of:
providing computer codes of a setting interface via the network electronic device to the external display device, and the computer codes are loaded to the external display device and using the external display device to display the setting interface used for inputting the configuration information according to the setting interface.

11. A network electronic device, having a transmission function of a wireless personal area network to selectively transmit a wireless link signal toward an external display device for matched connection and input configuration information via the external display device for network connection setting of the network electronic device, wherein the external device also has a transmission function of a wireless personal area network to receive the wireless link signal.

12. The network electronic device as claimed in claim 11, wherein the network electronic device captures images to create image information after finishing network connection setting, and the external display device synchronically receives and displays the image information and is used for inputting image adjustment information according to the image information to adjust the shooting angle and focusing distance of the network electronic device.

13. The network electronic device as claimed in claim 11, wherein both the network electronic device and the external display device have bluetooth transmission interfaces to establish the wireless personal area network.

14. The network electronic device as claimed in claim 11, wherein the network electronic device has computer codes of a setting interface stored therein, and the computer codes are loaded to the external display device and the setting interface is displayed on the external display device for inputting the configuration information according to the setting interface.

15. The network electronic device as claimed in claim 11, wherein the network electronic device is an IP cam.
